(19) United States
(12) Patent Application Publication
(10) Pub. No.: US 2010/0194683 A1
(43) Pub. Date: Aug. 5, 2010

(54) MULTIPLE SCREEN DISPLAY DEVICE AND METHOD

(76) Inventors: John D. Piper, Cambridgeshire (GB); Roberto Pansolli, Rome (IT)

Correspondence Address: Raymond L. Owens;Patent Legal Staff, Eastman Kodak Company, 343 State Street, Rochester, NY, 14650-2201, US

(21) Appl. No.: 12/698,177

(22) Filed: Feb. 2, 2010

(30) Foreign Application Priority Data
Feb. 3, 2009 (GB) 0901646.0

(51) Int. Cl. G09G 5/00

(52) U.S. Cl. 345/156; 345/1.1; 345/2.1

(57) ABSTRACT

Image browsing method and display device having a body with a plurality of display faces according to different planes, a plurality of display screens able to simultaneously display different digital images, the screens being respectively on different display faces of the body, image selection means for selecting a plurality of digital images in an image collection to be displayed on the screens; and motion sensors connected to the image selection means to trigger a display change, the display change comprising the replacement of the display of at least one image on at least one of the display screens by another image from the image collection, as a function of the device motion.

### FIELD OF THE INVENTION

The present invention relates to a multiple screen display device and method dedicated to the display of digital images and especially digital images of large image collections. The term “images” is understood as encompassing both still images and images of motion pictures. The invention aims to make the image viewing and browsing easy and convivial. Applications of the invention can be found, for example, in the domestic context of sharing photos and videos, in the professional context, for photomontage, public address, as well as in the context of artistic creation and exhibition.

### BACKGROUND OF THE INVENTION

With an increasing use of digital cameras, along with the digitization of existing photograph collections, it is not uncommon for a personal image collection to contain many thousands of images. The high number of images increases the difficulty of quick retrieval of desired images in an image collection. Also many images in an image collection are somehow lost for a user if the user does not remember such images or does not remember how to get access to such images. Comparable difficulties appear for users having no prior knowledge of the content of an image collection and for which it is not possible to view all of them. To obviate at least in part such difficulties, multimedia devices and image viewing devices sometimes offer image sorting and classification tools. The images can, for example, be classified in subsets of images having common features. The images can also be ordered based on a time data for a sequential display.

Although made easier by the classification tools, the conviviality of a browsing experience remains strongly dependent on the display and the user interface used to control the display.

U.S. Patent Application Publication No. 2007/0247439 discloses a spherical display and control device allowing a change in the display in response to sensing data from sensors.

There however remains a need for a viewing device designed for browsing through image collections, the device having a shape and a behavior adapted to usual image classification.

### SUMMARY OF THE INVENTION

The invention aims to provide to the user a natural and intuitive image viewing and image-browsing device and method.

An additional aim is to give the user easy access to large image collections and easy control of browsing directions through the collections.

Yet another aim is to provide a seamless display and a corresponding friendly interface.

The invention therefore provides an image browsing and display device comprising:

a body with a plurality of display faces according to different planes,

a plurality of display screens able to simultaneously display different digital images, the screens being respectively on different display faces of the body,

image selection means for selecting a plurality of digital images to be displayed on the screens, in an image collection, and motion sensors connected to the image selection means to trigger the replacement of the display of at least one image on at least one of the display screens by another image from the image collection, as a function of the device motion.

The body preferably comprises at least two screens on two different external display faces, and still preferably a plurality of screens respectively on adjacent display faces. The device may also have respectively one screen on each of its display faces.

The body is preferably sized so that a user can easily hold it in his/her hands and shake, rotate or anyhow move the body of the display device so as to control the display.

Although motion detection means, such as a camera, could be outside the body of the device, the motion detection means are preferably motion sensors located within the body. The motion sensors may include one or more sensors such as accelerometers, gravity sensors, gyroscopes, cameras, photodiodes and electronic compass.

The motion that is detected or measured can be a relative motion with respect to the device body, i.e. a person or an object moving around the object. Preferably however the motion is considered as the motion of the device body itself with respect to its environment/the earth.

The motion can be detected in the form of an acceleration, in the form of an angular tilt, in the form of a light variation, a vibration, a measurement of an orientation relative to the earth magnetic field etc.

The detection of a motion is then used to trigger a change in the image display according to predetermined display change rules.

The change may affect one screen, a plurality of screens or even all the screens. As an example, the motion detection means may include shake detection means and according to one possible rule, a display change of all screens can be triggered upon shake detection.

The shake detection means may include a photo-sensor used to detect a pseudo-cyclic variation in ambient light or an accelerometer to detect a pseudo-cyclic variation in acceleration.

According to an improvement of the invention the device may also comprise a user interface to detect which display face the user is watching, or deemed to be watching. The user interface may comprise sensors to detect user interaction with the device, light sensors or may comprise the above mentioned motion sensors. The outputs of such sensors are used or combined to deduce which display face the user is watching. The deduction can be based on inference rules or a weighted calculation to determine which display face a user is watching, or at least a probability the user is watching a given display face.

As an example, if the device comprises a user interface in the form of sensitive screens, the fact of touching a screen can be interpreted as the user being watching the display face that has just been touched. The display face the user is watching can also be deduced from the fact that the user has first touched a display face and the fact that the device has been rotated by a given angle about a given axis since a display face has been touched.

Uses of accelerometers offer alternative input modality to touch sensitive screens. With the use of accelerometers, touch screen will not be required, however touch screens may also be used as additional sensory inputs. In this case, when a user taps on one of the display faces, such a tap, and its orientation, may be sensed by the accelerometers. The accelerometers are then also part of the user interface. Filter and threshold means on the accelerometers may be used to distinguish the short and impulsive character of a tap from a more smooth motion such a rotation. In turn the orientation of the acceleration gained through comparison of output signal of at least two accelerometers having different axis may be used to determine which display face has been tapped. This display face can then be considered as the display face the user is watching.

Especially, the combination of electronic compass and accelerometer data from tap can be used to define the display surface of interest to the user and the orientation of the device in 3D space in relation to the user. Rotation of the device in any axis can then be related to this orientation.

The device orientation at the time of tapping can therefore be set by an accelerometer measuring the axis of gravity and an electronic compass measuring the axis of magnetic field in relation to the device. This allows setting the orientation of device in relation to user and defining the display screen of interest. If the user changes his/her viewing angle or rotates his/her position while holding the device the user would then have to reset the display surface of interest by tapping again beyond a certain threshold.

The axis which are preferably perpendicular to the device display faces may be set to an origin orientation, for example, such that one axis is left to right, a second axis is up down and a third axis is towards and away from the user's gaze direction. This may all be measured relative to the earth's magnetic and gravitational fields. This origin orientation can then directly be related to how the user is holding and viewing the device. Any rotation of the device can then in turn be measured to this origin orientation.

A threshold angle may be set around the origin orientation, such that rotation within that threshold does not affect image changes. As explained further below, once the rotation is greater than the threshold level the image may change on the hidden display face (away from user) according to browsing direction.

Two directions of rotation such as horizontal plane or left to right around the user's visual axis, and vertical plane or up and down around the visual axis may be considered.

The interpretation of the accelerometer signals relating to the earth's gravitational field by the processor can determine if there is a device rotation in the vertical plane.

The interpretation of the electronic compass signals relating to the earth's magnetic field by the processor can determine if there is cube rotation in the horizontal plane.

The device motion can of course also be computed in other reference planes.

Still as an example, if the user interface comprises light sensors on each display face, the fact that one light sensor detects lower light intensity may be interpreted as this display face being hidden to the user. This happens, for example, when the device is placed on this display face on a support which hides the display face, or when the user holds this display face in his/her hands. One or more display faces located opposite to the hidden display face can in turn be considered as being the display faces the user is watching.

The detection of the display face the user is watching or the user is deemed to be watching can be used to display additional information on the screen on that display face.

As mentioned above, another interesting use of this data is to trigger the change of image display on one or more screens that are not viewed by the user. Such screens are screens on a display face opposite to the display face the user is watching or at least a display face remote from the display face the user is watching.

The image change on a display face hidden to the user allows not to disturb the user's image viewing and browsing activity and to simulate an endless succession of different images.

The selection of the images that are displayed is made by built-in or remote image selection means. The image selection means can also be partially built-in and partially remote. The image selection means may comprise image capture devices, such as a camera, one or more memories to store image collections and computation means able to adapt the images selection as a function of possible user input. Especially, the display device can be connected to a personal computer via a wireless transmitter and receiver such as a wireless USB transmitter.

One important user input that may be used for image selection is given by the motion sensors i.e. the output signals of the accelerometers, gyroscopes, compass etc. Therefore the image selection means, and in turn the display is controlled by the motion detection means.

User input may also include other explicit or implicit user input collected by an ad-hoc user interface or sensor. As an example, one or more display faces may be touch sensitive or comprise touch-sensitive display screens. Other commands such as buttons, sensitive pads, actuators etc. can also be used.

If a plurality of user interfaces is present, different user interfaces may also be respectively allocated to different predetermined image-processing tasks so as to trigger a corresponding image processing upon interaction. This allows both very simple interfaces such as a single touch sensitive pad on one or on several display faces and an accurate control of the device behavior.

According to another aspect, the image processing task or the operation that is triggered by the interface can be set as a function of a device motion determined by the motion sensors.

As an example, a rotation of the device can change the function of a given button or sensitive pad.

The invention is also related to an image scrolling and display method using a device as previously described.

The method comprises:

the selection of a plurality of images in an image collection

the display of the selected images respectively on the plurality of screens of the device

detection of a possible motion of the device, and

replacing the display of at least one image on at least one screen, by another image from the image collection as a function of the device motion.

The method may also comprise the detection of a display face a user is watching. The change of the display can then be made on a display face opposite of or remote from the display face a user is watching. This allows a seamless or even imperceptible change of the displayed images.

According to another improvement, the images to be displayed may be ordered in at least one images order, the images being displayed on screens of a at least one set of adjacent display faces of the device, according to respectively at least one order. Upon detection of a rotation motion of the device about at least one axis, the display of at least one display screen of the set of adjacent display faces is then changed so as to display an image having a higher rank, respectively a lower rank, in the respective image order, as a function of a direction of rotation.

The rotation axis considered for determining on which set of adjacent display faces the image change is made can be predetermined or can be a function of the display face the user is deemed to be watching.

According to still another improvement,

the images of the collection are sorted in at least a first and at least a second image subsets,

images of the first subset are respectively displayed on screens of a first set of adjacent display faces of the device and images of the second subset are displayed on screens of a second set of adjacent display faces of the device, the first and second sets of adjacent display faces being respectively associated to a first and second rotation axis, and

upon detection of a rotation motion of the device about at least one of the first and second rotation axis, the display of at least one display screen is changed respectively with images from the first and second image subsets.

Again, the image change is preferably made on a screen opposite to the screen the user is deemed to be watching, and can be made according to an order in each subset.

The first and second axis can be predetermined or linked to the display face detected as the display face the user is watching. As an example, the first and second rotation axis can respectively be parallel and perpendicular to the plane of the display face the user is deemed to be watching.

All the displayed images can also be replaced by images from the same or another subset if one amongst a predetermined interaction, a detection of a predetermined motion or the detection of an absence of motion over a preset time duration is detected. As an example, the predetermined interaction can be an interaction with a given sensitive pad, such as a double click on the touch screen the user is watching. The predetermined motion can be a rotation about a given axis or as mentioned previously, merely the shaking of the device.

Other features and advantages of the invention will appear in the following description of the figures illustrating possible embodiments of the invention.

### BRIEF DESCRIPTION OF THE DRAWINGS

FIG. 1 is a schematic view of a device illustrating a possible embodiment of a device according to the invention;

FIG. 2 is a flow chart illustrating a possible display method using a device according to the invention;

FIG. 3 is a simplified view of the device of FIG. 1 and illustrates a possible layout for display and rotation planes and axis; and

FIG. 4 is a flow chart illustrating one aspect of the method of FIG. 2 including the calculation of an angular position of the device and the use of the angular position to adapt the display.

### DETAILED DESCRIPTION OF THE INVENTION

In the following description reference is made to a display device that has a cubic body. It is however stressed that other shapes and especially polyhedral shapes are also suitable. The body can be pyramidal, parallelepipedal or any other shape where different display faces have different viewing angles for a user watching the device. Especially, the body can have a flat parallelepipedal body, like a book, with two main opposite display faces, each display face having a display screen. The following description related to a cube applies therefore also to such devices having different shapes.

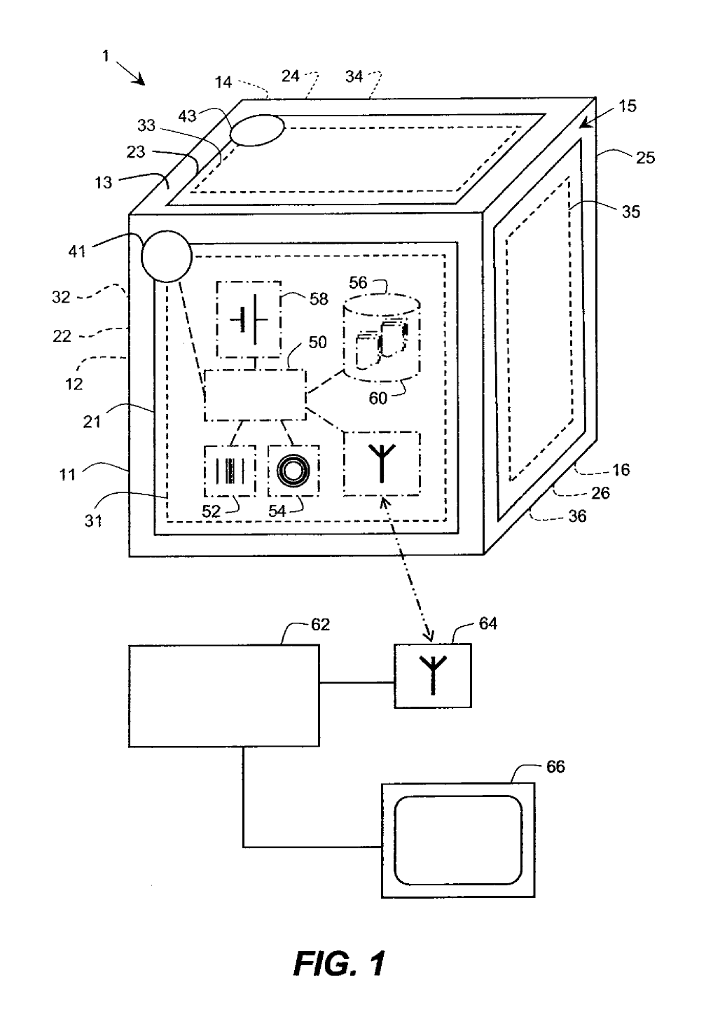

The device of FIG. 1 has a body 1 with six flat external display faces 11, 12, 13, 14, 15 and 16. Each display face has a display screen 21, 22, 23, 24, 25, 26 substantially in the plane of the display face and covering a major surface of the display face. The display screens are for example liquid crystal or organic light emitting diode display devices. Although this would be less suitable, some display faces could have no screen. The screen may then be replaced by a still image or by a user interface such as a keyboard, or a touch pad.

The display screens 21, 22, 23, 24, 25 and 26 are touch-sensitive screens. They are each featured with one or more transparent touch pads 31, 32, 33, 34, 35 and 36 on their surface respectively. Here again some display faces may have no touch pad. The sensitive screens with their touch pads can be used as interaction detection means to detect how and whether a user holds the device but also as a user interface allowing a user to select or trigger any function or image processing task. The touch pads may still be used to determine reference rotation axis with respect to display faces that are touched, so as to compute device motion.

Reference signs 41 and 43 correspond to light sensors. The light sensors may be mere photo diodes but could also include a digital camera in a more sophisticated embodiment.

User interactions with the device are collected and analyzed by a built-in processor 50.

The processor is therefore connected to the touch sensitive display screens 21-26 and to possible other sensors located at the surface of the device. The processor is also connected to an accelerometer 52 and an electronic compass 54 to collect acceleration and compass signals and to calculate, among others, angular positions and or rotation motion of the device.

The accelerometer 52 is preferably a three-axis accelerometer, sensitive to accelerations components according to three distinct and preferably orthogonal acceleration directions. The accelerometer is sensitive to changes according to the three-axis of the components of any acceleration and especially of acceleration due to gravity. The acceleration of gravity being along a vertical line, the accelerometer signals may therefore be used to compute possible angular positions and rotations about rotation axis in a plane parallel to the earth's surface.

The accelerometers may sense slow changes in gravity acceleration responsive to a rotation of the device, but may also sense strong accelerations due to interactions of the user with the device such as hitting the device, shaking the device, or taping a display face thereof. Filtering the acceleration signals can make discrimination between different types of accelerations and motions. Low amplitude or low frequency signals relate to rotation while high amplitude and high frequency signals relate to impact. A shake motion implies a pseudo periodic signal. The discrimination can also be made by signal processing in the processor 50.

Rapid (short, sharp) changes in accelerometer signals in one direction indicate tapping of the device. From the direction of tap information provided by the accelerometer the processor interprets these signals to determine which display had been tapped, as the display display faces are mapped to the position of the accelerometer axis, thus determining which display is facing the user and which display display face is away from the user.

Multiple taps can be measured by looking for these accelerometer “tap” characteristics over a set time period once the first tap has been detected. The double tap excites the accelerometer, which is able to define the direction of tapping.

The time period between the taps are predefined e.g., 0.2 seconds. A double tap with a time period between the taps of over 0.2 seconds will not therefore activate the state shift.

The interpretation by the processor of the accelerometer signals that indicate a rapid changes in alternating opposing directions for a set period of time can determine if shaking is taking place.

After defining the display surface of interest with a tap, a viewing plane is defined. This viewing plane can remain constant during browsing until the device is tapped again. The viewing plane is defined relative to the earth's gravitation and magnetic fields.

During rotation of the device the angle of the display surface which best matches the viewing plane angle, set at tap, is always considered the display surface of interest.

The position of the “hero” display in x-y-z axis of the device is defined relative to a vertical and horizontal line defined by the earth's gravitation and magnetic fields indicated by the electronic compass.

Only one or two axis accelerometers or accelerometers having more sensitivity axis may also be used, depending on the general shape and the number of display faces of the device.

In the same way the electronic compass, which is sensitive to the earth's magnetic fields, measures the orientation of the device relative to a horizontal, north-south line.

The signal from the compass can therefore be used to compute rotation about a vertical axis.

Possibly the signal may be derived or filtered to distinguish impulsive signals from continuously varying signals.

Another, or the above mentioned built-in processor 50 may perform other tasks and especially may be used to retrieve images to be displayed from an image collection stored in a built-in memory 56.

The processor is also connected to a power supply 58 such as, for example, a rechargeable battery and charging inlet, and is connected to wireless connection means 60.

The wireless connection means 60, symbolized in the form of an antenna, allow the device to exchange data, and even possibly energy with a personal computer 62 or another remote device having a corresponding receiver transmitter 64. All or part of the image storage, as well as all or part of the computation power of the device can therefore be located in the remote device. The remote device can also be used merely to renew or to add new images to the image collection already stored in the memory 56 of the device.

The wireless connection between the device and a remote computer may additionally be used to exchange motion detection data. The motion of the display device can therefore be used to also change the display on one or more remote display screens 66.

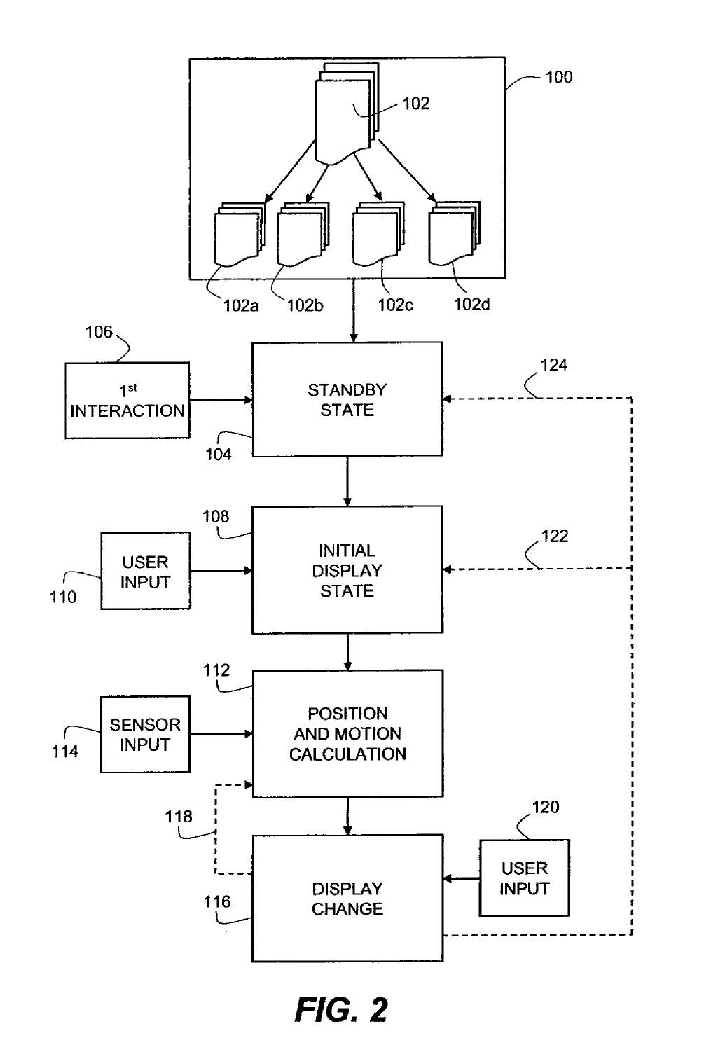

A possible use of the display device of FIG. 1 is now considered with reference to FIG. 2.

A first optional preliminary step comprises a sorting step 100 that is used to sort an image collection 102 into a plurality of image subsets 102a, 102b, 102c, 102d having respectively common features. The sorting can be made based on user input, based on image metadata, based on low level or high level image analysis, or may merely be based on the fact that images are already in a same data file in a computer memory. Examples of low-level analysis are color, light or spatial frequency analysis. High-level analysis may include shape detection, context detection, display face detection, and display face recognition.

A given subset therefore comprises images having common features. This may be images captured at a same place, such as a given scenic tourist place, images from a same event, such as a birthday, a wedding etc., images from a same person, images taken in a same time frame, etc. An image may belong to several subsets if the image shares common features with images from different subsets.

In addition, the sorting step may also comprise the ordering of the images within each subset of images. Different kind of parameters or metrics can be used for the ordering, but the order is preferably chronological. It may be based on the time of capture embedded in image metadata. Other metrics such as user preference, number of times an image has been previously viewed, etc. may also be used for ordering.

The preliminary sorting and ordering step may be carried out on a remote computer, but can also be carried out in part within the display device, using user interface thereof and the built-in processor.

The memory of the display device can also be loaded up with already sorted images.

The above does not prejudice the use of the display device to view unsorted images. Also, unsorted images can be automatically sorted in arbitrary categories and in an arbitrary random order by the device processor.

Stand-by state 104 of FIG. 2 corresponds to a stand-by or “sleeping” state of the display device. In this state the display on the device screens is not a function of motion. In the stand-by state the display screens may be switched off or may display random sequences of images picked in the local or in a remote image collection, or still may display any dedicated standby images.

Upon a first interaction 106 of a user with the device images from one more subsets of the image collection 102 are selected and displayed. The number of selected images corresponds preferably to the number of display faces having a display screen. This corresponds to an initial display state 108.

The first “wake-up” interaction 106 of a user may be sensed in different ways.

A light sensor detecting a light change from a relative darkness to a brighter environment can be interpreted as the fact that the user has taken the device from a position where it was placed on a display face bearing the light sensor.

A first interaction can also be a sudden detection of accelerations or change in acceleration after a period where no acceleration or no change in acceleration was sensed.

A first interaction may be the fact that one or more sensitive screens of the device have been touched after a period without contact or without change in contact.

A first interaction may still be an impulsive or a pseudo periodic acceleration resulting from the user having taped or shaken the device.

As indicated above, the first interaction 106 is used to switch the display device from the stand-by state 104 into the initial display state 108.

In the initial display state 108 subsequent images respectively from one or more subsets of images are preferably displayed on display screens located respectively on adjacent display faces of the device.

While in the display state, the sensors of the device including the motion sensors are in a user interface mode allowing the user to control the display or to perforin possible image processing on the already displayed images. Especially the sensors may be in a mode allowing a user to indicate which display face he/she is watching.

Possible user inputs 110 are: a tap on a display face, a double tap, a touch or double touch on a sensitive screen, or a detection of light. A mentioned, such inputs can be used to determine which display face(s) the user is watching or deemed to be watching. This display face is called the display face of interest.

The determination of the display face(s) of interest can be based on a single input or may be computed as a combination of different types of input. Inference rules based on different possible interactions of the user with the device may be used to determine the display face or interest.

Possibly the first interaction 106 may already be used to determine the display face of interest.

A position and motion calculation step 112 takes into account the determination of the display face of interest as well as sensor inputs 114 from an accelerometer, gyroscope or compass to calculate possible rotations of the device. The signals of the motion sensors are also used to determine possibly one or more new display faces of interest upon rotation.

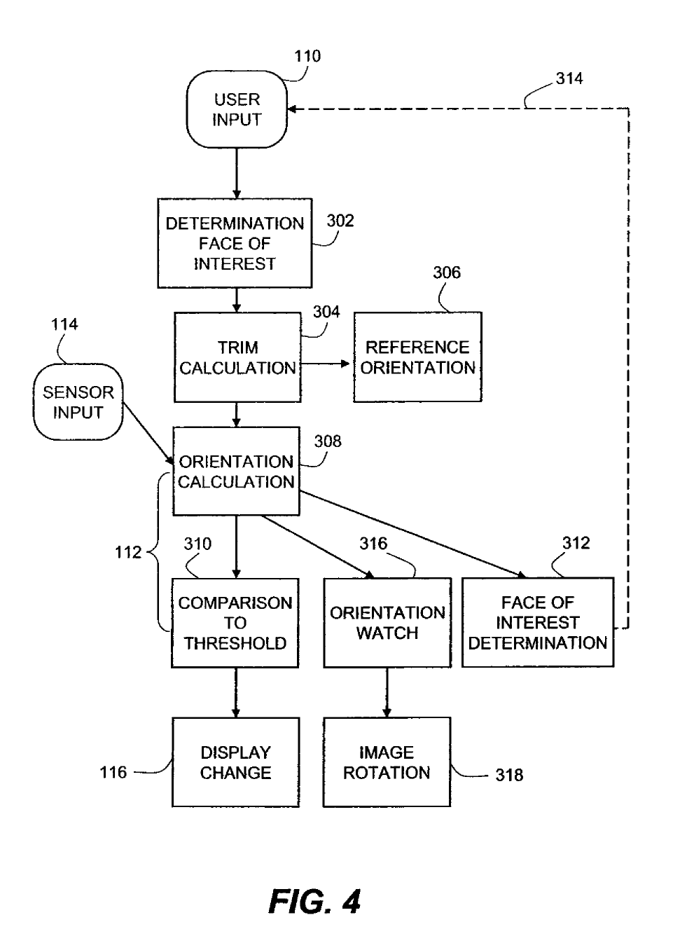

Additional details on the position and motion calculation step are given below with respect to the description of FIG. 4.

The determination of the motion of the device is then used to perform a display change step 116. The display change 116 may especially comprise the replacement of one or more displayed images by one or more new displayed images as a function of the motion. If a display face of interest has been previously determined the image change preferably occurs on one or more display faces opposite or remote from the display face of interest.

The motion detection, the update of the display face of interest and the display changes can be concomitant. This is shown by arrow 118 pointing back form display change step 116 to position and motion calculation step 112 of FIG. 2.

A differentiated user input 120, such as shaking the device or the fact that no motion sensor signal is measured over a given time duration can be used to bring the device back to the initial display state 108 or back to the stand-by state 104 respectively. Arrows 122 and 124 show this. In particular, all the displayed images may be simultaneously replaced by new and different images from the same or from different subsets of images.

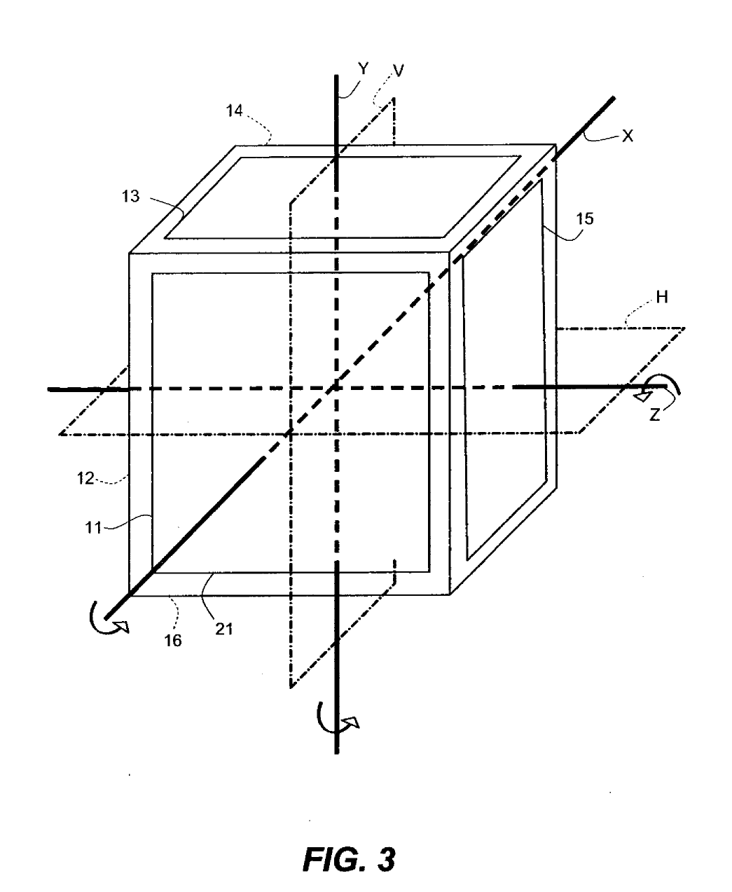

Turning now to FIG. 3 a device with a cubic shape and having a display screen on each of its six display faces is considered. It may be the same device as already described with reference to FIG. 1. Corresponding reference signs are used accordingly.

An assumption is made that the frontal display face 11 of FIG. 3 is the display face that has been identified or that will be identified as the display face of interest.

In the initial display state (108 in FIG. 2) images from two different subsets in the image collection are selected and are displayed on two different sets of adjacent display faces of the device.

In the device of FIG. 3, a first set of adjacent display faces comprises display faces perpendicular to a vertical plane V i.e. display faces 11, 13, 14 and 16. A second set of display faces comprises display faces 11, 12, 14 and 15, i.e. display faces perpendicular to horizontal plane H.

It is noted that the display face of interest is both part of the first and the second sets of adjacent display faces. Two images could be displayed on the screen 21 of the display face of interest 11. Preferably however a single image belonging to both of the two selected subsets of images can be displayed on the screen 21 of the display face of interest. This may apply as well for the display face opposite to the display face of interest.

As a mere example a first and a second subsets of images may be images corresponding to “John's birthday” and “John” respectively. The first subset comprises all the images taken at a specific event: John's birthday. The second subset comprises all the images in which the display face of a given person has been identified: John's display face.

Most likely at least one image taken at John's birthday comprises John's face. Such an image belongs to the two subsets and is then a candidate to be displayed on the screen 21 of the display face of interest.

The images in the subsets of images can be ordered. As mentioned previously, the order may be a chronological time order, a preference order or an order according to any other metric. Turning back to the previous example, images displayed on the display faces perpendicular to vertical plane V may all belong to the subset of the images captured at John's birthday and may be displayed in a chronological order clockwise around axis Z. In other terms, the image displayed on the upper display face 13 was captured later than the image displayed on the screen of the display face of interest 11, and the latter was captured in turn later than the image displayed on the lower display face 16.

The same may apply to the images displayed on the display faces 11, 12 and 15, perpendicular to plane H. Still using the previous example, the images displayed on the display faces perpendicular to plane H are images on which John's face is identified, wherever and whenever such images have been captured, and the images displayed on the display faces at the right and the left of the display face of interest may respectively correspond to capture times earlier and later than the capture time of the image displayed on the display face of interest. The capture time stamp is a usual metadata of digital images.

The terms upper, lower, right and left refer to the cubic device as it appears on FIG. 3. On the same device reference 14 corresponds to the display face remote from the display face of interest 11, and is hidden to a viewer watching the display face of interest 11.

Preferably the display change occurs on the display face opposite to the display face of interest, therefore called the “hidden display face”. The display change is triggered by the rotation of the device and is function on how the user rotates the display.

Assuming that the user rotates the cubic device of FIG. 3 about an axis Z parallel to the horizontal plane H and perpendicular to the vertical plane V then the image displayed on the hidden display face 14 is replaced by an image selected in the first subset of images associated to the display faces perpendicular to plane V. In the previous example the new image is picked in the “John's birthday” subset.

If the images are ordered the new image may be an image subsequent to the image displayed on the upper display face 13 or an image previous to the image displayed on the lower display face 16. The choice of a subsequent or previous image is depending respectively on the anti-clockwise or clockwise direction of rotation about horizontal axis Z.

The same applies for a rotation about the vertical axis Y except that the new image is picked in the second subset: “John”. Again the sequential order for image replacement depends on the sense of rotation about axis Y.

If a rotation is about both axes, a weighted combination can be used to determine the main rotation and to replace the image with respect to the rotation axis of the main rotation, with a threshold angle.

As an example, where the user rotates the device at a 45 degrees angle relative to an axis, the device may select the higher rank image.

For devices having higher or lower degrees of symmetry and respectively a higher or lower number of adjacent sets of display faces, new images to be displayed can be taken in more or less subsets of images in the image collection. Also the device may comprise more than one remote or hidden display face on which the display is changed.

As an example, on a flat device having only two display faces with each a display screen, a display face of interest and a hidden display face can be determined only. However depending on the axis of rotations and the angular components about these axis, image change on the hidden display face may nevertheless involve a choice between more than one subsets of images in the image collection.

The swap from subsets of images in the collection to completely different subsets can also result from the detection of a pseudo-periodic shake motion of the device.

The motion the user gives to the device is not necessarily merely horizontal or merely vertical but may be a combination of rotations having components about three axes X, Y and Z. Also, the rotations are not made necessarily as from an initial position where the display faces are perfectly horizontal or perfectly vertical as in FIG. 3. However the rotations may be decomposed according to two or more non-parallel axis with angular components about each of the axis. An absolute reference axis system may be set with respect to gravity and compass directions. A reference axis system may also be bound to the display faces of the device. A viewing plane, as described earlier, may therefore be preferably set as the reference for all rotations until the device is tapped again.

The motion sensor signals are therefore used to calculate a trim, to calculate rotation angular components as from the trim, to compare the rotation angular components to a set of threshold components and finally to trigger an images change accordingly.

These aspects are considered with respect to the diagram of FIG. 4. A first block on FIG. 4 corresponds to the sensing of a user input 110 such as an interaction with the device likely to be used for determination of a display face of interest. As mentioned above the user input 110 may come from motion sensor, as a response to a tap on a display face or may come form other sensors or user interfaces. When the user input 110 is a tap on a display face, the display face that has been tapped may be determined based on the direction and the amplitude of the acceleration impulse sensed by three accelerometers or the three-axis accelerometer.

The determination of the display face of interest and the plane of the display face of interest corresponds to determination of display face of interest block 302. As soon as the display face of interest is determined a device trim calculation 304 is performed based again on motion sensor input. Accelerometers may provide input signals corresponding to gravity and enable the calculation of the trim with respect to rotations axis X and Z in the horizontal plane H, with reference to FIG. 3. Compass or gyroscopic signals may be used to determine a position about axis Y perpendicular to the plane H. This data is here also considered as a data determining the trim. The trim data therefore determines an initial reference orientation 306 of the display face or interest and the orientation of all the display faces of the device, assuming that the device is not deformable. The trim calculation may also be used to set a axis reference in which further rotations are expressed. For purpose of simplicity, the reference axes are considered as the axes X, Y, Z of FIG. 3.

Upon new motion detected by sensor input 114, an actual orientation calculation 308 is performed. The calculated orientation can be based on compass and accelerometer data can again be expressed as angular components about the axis system XYZ.

A comparison to threshold step 310 comprises the comparison of the angular components to threshold angular components so as to determine whether an image change has to be triggered or not.

The orientation calculation 308 and the comparison to threshold, step 310 are sub steps of the position and motion calculation step 112 referred to in the description of FIG. 2.

As soon as an angular component about an axis exceeds a threshold value a next image may be displayed from a subset or images corresponding to a set of adjacent display faces parallel to such rotation axis. More generally a weighted calculation of a rotation about two or more axis may be used to trigger the display change step 116 if exceeding a predetermined threshold.

The threshold angles may be given with respect to the initial reference position in the initial or permanent X, Y, Z axes system.

The initial reference position and plane may be maintained until a new user input 110 likely to be used to determine a display face of interest or may be updated as a function of the actual orientation calculation 308.

A display face of interest determination step 312 compares the angular components to threshold angular components and compares the actual orientation with the trim of the reference orientation 306 to continuously the determine display face of interest. When the rotation exceeds given preset threshold angles, one or more new display faces of interest and in turn, one or more new hidden display faces are determined.

The update of the display face of interest may be based on the device rotation on the assumption that the user's position remains unchanged.

The determination of the display face or interest, and respectively other display faces, may at any time be overruled by user input on an interface or as a new tap on a display face. This is shown with an arrow 314.

Orientation watch step 316 determines the direction of earth gravity and the angular position of each display face with respect to the direction of earth gravity. The direction of earth gravity can be directly obtained as a low-pass filtering of the accelerometer signals, which are subject to gravity. The direction of gravity can then be matched with the actual angular component of the display faces so that a viewing plane as described earlier may therefore be set as the reference for all rotations until the device is tapped again. As far as the images to be displayed have a metadata indicative of their viewing direction, or as far as the viewing direction can be calculated based on high level image analysis, the viewing direction of each digital image can be matched respectively with the relative orientation of the display face on which the image is to be displayed and the image can be rotated if the angular mismatch exceeds a threshold values. The orientation of the display face the user is watching, and in turn the orientation of the displayed image are determined, for example, with respect to the lowest edge of the display surface or screen in the viewing plane. Image rotation step 318 is used to rotate the image as appropriate.

The invention has been described in detail with particular reference to certain preferred embodiments thereof, but it will be understood that variations and modifications can be effected within the spirit and scope of the invention.

### PARTS LIST

1 body
11 face
12 face
13 face
14 face
15 face
16 face
21 display screen
22 display screen
23 display screen
24 display screen
25 display screen
26 display screen
31 touch pad
32 touch pad
33 touch pad
34 touch pad
35 touch pad
36 touch pad
41 light sensor
43 light sensor
50 processor
52 accelerometer
54 compass
56 memory
58 power supply
60 wireless connection means
62 personal computer
64 receiver transmitter
66 remote display screen
100 sorting step
102 image collection
102a image subset
102b image subset
102c image subset
102d image subset
104 stand-by state
106 first interaction
108 initial display state
110 user input
112 position and motion calculation step
114 sensor input
116 display change step
118 arrow
120 user input
122 arrow
124 arrow
302 determination of display face of interest block
304 device trim calculation
306 reference orientation
308 orientation calculation
310 comparison to threshold step
312 face of interest determination step
314 arrow
316 orientation watch step
318 image rotation step
H horizontal plane
V vertical plane
X axis
Y axis
Z axis

1. Image browsing and display device having:
a body with a plurality of display faces according to different planes,
a plurality of display screens able to simultaneously display different digital images, the screens being respectively on different display faces of the body,
image selection means for selecting a plurality of digital images in an image collection to be displayed on the screens; and
motion sensors connected to the image selection means to trigger a display change, the display change comprising the replacement of the display of at least one image on at least one of the display screens by another image from the image collection, as a function of the device motion.

2. Device according to claim 1, wherein the motion sensors comprise at least one accelerometer and an electronic compass.

3. Device according to claim 1, further comprising at least one user interface.

4. Device according to claim 3 comprising a processor receiving signals from the user interface or from the motion sensors to determine one display face amongst the plurality of display faces deemed to be remote from a user, and for triggering the display change on the remote display face.

5. Device according to claim 1 comprising means for sensing gravitational acceleration and for changing image orientation of displayed images as a function of gravitational acceleration.

6. Method for image scrolling and display on a device according to claim 1 comprising:
selection of a plurality of images in an image collection;
display of the selected images respectively on the plurality of screens of the device;
determination of a possible motion of the device; and
replacement of at least one displayed image on at least one screen by another image from the image collection as a function of the device motion.

7. The method according to claim 6 wherein the images of the collection are ordered in at least one image order, the images being displayed on screens of a at least one set of adjacent display faces of the device, according to respectively the at least one order, and, upon detection of a rotation motion of the device about at least one axis, changing the display of at least one display screen of the set of adjacent display faces, so as to display an image having a higher rank, respectively a lower rank, in the respective image order, as a function of a direction of rotation.

8. The method according to claim 6, wherein:
the images are classified in at least a first and a second image subsets, images of the first subset being respectively displayed on screens of a first set of adjacent display faces of the device and images of the second subset being displayed on screens of a second set of adjacent display faces of the device, the first and second sets of adjacent display faces being respectively associated to a first and second rotation axis; and
upon detection of a rotation motion of the device about at least one of the first and second rotation axis, changing the display of at least one display screen respectively with images from the first and second image subsets.

9. The method according to claim 6, further comprising the detection of a display face of the device that a user is watching and wherein the image display is changed on at least one display face remote to the display face the user is watching.

10. The method according to claim 9, wherein the display is changed upon rotation of the device about an angle exceeding at least one threshold rotation angle, with respect to an initial device position, the initial position being determined upon user interaction with the device.

11. The method according to claim 6, further comprising:
generating a gravity detection signal and
orienting the displayed images as a function of the gravity detection signal.

12. The method according to claim 6, wherein all images displayed on display screens are replaced by other images, upon detection of shaking motion or detection of an absence of motion over a preset duration of time.
